(19) United States
(12) Patent Application Publication
(10) Pub. No.: US 2025/0304193 A1
(43) Pub. Date: Oct. 2, 2025

(54) SYSTEM FOR WEIGHT DISTRIBUTION AND WHEEL ADJUSTMENT OF A TRAILER

(71) Applicant: Range Energy Inc., Mountain View, CA (US)

(72) Inventors: Ali Javidan, Sunnyvale, CA (US); Kyle Foley, Half Moon Bay, CA (US); Bryan Booth, San Mateo, CA (US); Ryan Flatland, Redwood City, CA (US); Collin MacGregor, Redwood City, CA (US)

(21) Appl. No.: 19/096,265

(22) Filed: Mar. 31, 2025

Related U.S. Application Data
(60) Provisional application No. 63/571,922, filed on Mar. 29, 2024.

(51) Int. Cl. B62D 53/06

(52) U.S. Cl. CPC B62D 53/068

(57) ABSTRACT

A system for weight distribution of a trailer includes: a trailer chassis including a vehicle coupler arranged on a first end of the trailer chassis and configured to couple to a tow vehicle; a battery assembly arranged on the first end of the trailer chassis and configured to transiently install on a left rail and a right rail of the trailer over a range of longitudinal positions; a bogie including a chassis configured to transiently install on the left rail and the right rail of the trailer over the range of longitudinal positions and arranged on the second end of the trailer chassis opposite the first end, a driven axle suspended from the chassis, and a motor coupled to the driven axle; and a bogie actuator configured to longitudinally displace the bogie along the trailer chassis.

### CROSS-REFERENCE TO RELATED APPLICATIONS

This Application claims the benefit of U.S. Provisional Patent Application No. 63/571,922, filed on 29 Mar. 2024, which is incorporated in its entirety by this reference.

### TECHNICAL FIELD

This invention relates generally to the field of overland trucking and more specifically to a new and useful system for weight distribution and wheel adjustment of a trailer in the field of overland trucking.

### BRIEF DESCRIPTION OF THE FIGURES

FIGS. 1A, 1B, and 1C are schematic representations of a system; and

FIG. 2 is a schematic representation of one variation of the system.

### DESCRIPTION OF THE EMBODIMENTS

The following description of embodiments of the invention is not intended to limit the invention to these embodiments but rather to enable a person skilled in the art to make and use this invention. Variations, configurations, implementations, example implementations, and examples described herein are optional and are not exclusive to the variations, configurations, implementations, example implementations, and examples they describe. The invention described herein can include any and all permutations of these variations, configurations, implementations, example implementations, and examples.

### 1. System

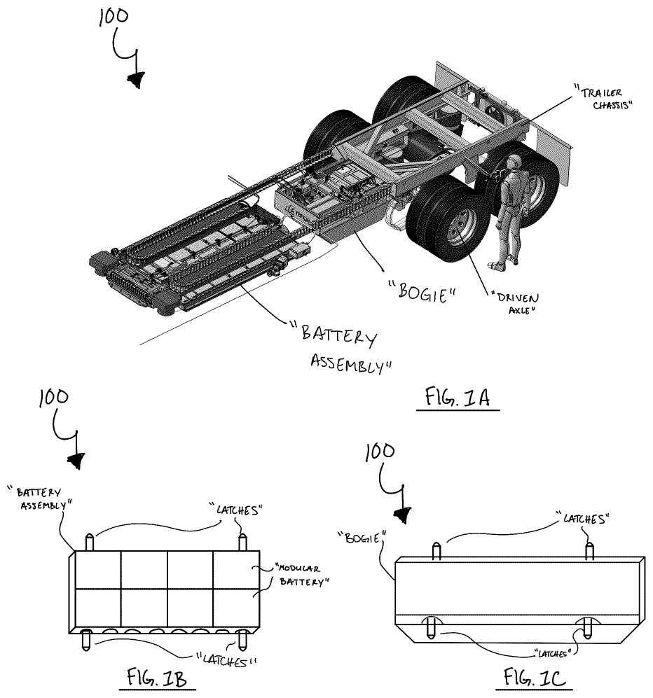

As shown in FIGS. 1A, 1B, and 1C, a system 100 for weight distribution of a trailer includes: a trailer chassis that includes a vehicle coupler arranged on a first end of the trailer chassis and configured to couple to a tow vehicle; and a battery assembly arranged on the first end of the trailer chassis and configured to transiently install on a left rail and a right rail of the trailer over a range of longitudinal positions. The system 100 further includes a bogie: including a chassis configured to transiently install on the left rail and the right rail of the trailer over the range of longitudinal positions and arranged on the second end of the trailer chassis opposite the first end; a driven axle suspended from the chassis; a motor coupled to the driven axle; and a bogie actuator configured to actuate the bogie.

The system 100 also includes a controller configured to, at an initial time: access a specification for the trailer defining a total weight for the trailer and defining a target length between the vehicle coupler and the driven axle; define a first target tow position of the bogie based on the target length between the vehicle coupler and the driven axle; define a second target tow position of the battery assembly based on the total weight for the trailer and the first target tow position; trigger the bogie actuator to advance the bogie to engage the battery assembly and drive the battery assembly to the second target tow position; and trigger the bogie actuator to withdraw the bogie to the first target tow position to balance a weight of the trailer, containing a first load, on the driven axle.

The controller is further configured to, at a first time: detect a first weight of the trailer, containing the first load, on the driven axle; and, in response to the first weight of the trailer falling within a target weight range of the trailer on the driven axle, enter a tow mode and trigger the battery assembly to supply electrical energy to the motor to output torque to the driven axle.

### 2. Applications

Generally, the system 100 defines an electric trailer that includes: a trailer chassis; a set of rails; a vehicle coupler; a battery assembly; a bogie; a set of sensors; and a controller.

More specifically, the system 100 includes: a bogie that transiently (e.g., temporarily) installs below the trailer chassis over a range of longitudinal positions over time, includes a driven axle and a motor coupled to the driven axle; a battery assembly or a set of modular batteries that enable a user to selectively adjust the battery capacity as a function of a weight distribution of the trailer; a set of sensors-such as a force sensor, an optical sensor, an inertial sensor, a proximity sensor, or a position sensor-configured to transmit signals representing conditions of the trailer; and a controller configured to autonomously transition between a service mode and a tow mode responsive to local conditions detected by the system 100.

Additionally, during a setup period, the controller can retrieve a drive route for the trailer defining a start location and a target location, a set of weight parameters, and/or a target battery capacity associated with the drive route entered by a user from a user portal. The controller can then estimate a target tow position of the bogie and of the battery assembly for each leg of the drive route based on the set of weight parameters and annotate each leg of the drive route with these target tow positions to generate a specification for the trailer.

During installation, the controller can extract a first target tow position of the bogie and the second target tow position of the battery assembly from the specification and selectively trigger a bogie actuator to drive the bogie and the battery assembly to the corresponding target tow position below the trailer chassis. The controller can then access position data from a set of proximity sensors coupled to the trailer chassis and interpret a position of the bogie via the set of proximity sensors to verify each target tow position. Further, the controller can access signals received from a load cell and interpret a weight of the trailer on the driven axle. Then, responsive to the weight exceeding a maximum weight limit on the driven axle, the controller can selectively adjust the target tow position of the bogie and the battery assembly to balance a weight distribution of the trailer. Alternatively, responsive to the weight falling below the maximum weight limit on the driven axle or within a target weight range, the controller can autonomously transition to a tow mode.

In the tow mode, the controller can selectively adjust the target tow position of the bogie and/or the battery assembly below the trailer chassis to achieve a target wheelbase—such as a distance between a center of a set of wheels coupled to the first end of the trailer chassis to a center of the set of driven wheels—defined by the user when the trailer is immobile for a duration of time.

In the service mode, the controller can unlock the set of latches of the bogie, locate the bogie in a service position, monitor the charge state of the battery assembly, and manipulate a set of booms coupled to the bogie to autonomously service the battery assembly. Alternatively, the controller can autonomously prepare the battery assembly for service and reduce the duration for the user to manually service the battery assembly.

Therefore the controller can autonomously transition between a service mode and a tow mode responsive to local conditions detected by the system 100. Additionally, while the trailer is stationary (e.g., docked, parked), the controller can selectively adjust the bogie and the battery assembly over a range of longitudinal positions below the trailer chassis and thereby, balance a weight distribution of the trailer on the driven axle without necessitating manual adjustments of the bogie and/or the battery assembly by an operator and without mechanical tools.

### 3. System

As described above, a system 100 for weight distribution of a trailer includes: a trailer chassis; a battery assembly; a bogie; a set of sensors; and a controller.

### 3.1 Trailer

Generally, the trailer includes: a trailer chassis; and a set of rails. The left rail and the right rail are coupled to the trailer chassis and run along a longitudinal axis of the trailer, extending parallel to and laterally offset from a longitudinal centerline, to form a channel below the trailer chassis of the trailer.

In one implementation, the trailer includes: a trailer chassis; a left rail coupled to the trailer chassis, extending parallel to and laterally offset from a longitudinal centerline of the trailer, and defining a first array of engagement features distributed along the left rail and longitudinally offset by a pitch distance; and a right rail coupled to the trailer chassis, extending parallel to and laterally offset from the longitudinal centerline of the trailer opposite the left rail, and defining a second array of engagement features distributed along the right rail and longitudinally offset by the pitch distance. In this implementation, the set of rails extend along a length of the trailer and define a channel below the trailer chassis. Alternatively, the set of rails extend along a portion of the length of the trailer and define a channel below the trailer chassis of the trailer.

Furthermore, the set of engagement features can include a bore, a slot, an aperture, or an indentation distributed along each rail and configured to engage and retain a corresponding latch of a bogie and/or a battery assembly, as further described below. However, each rail can include any other type of engagement feature configured to engage and retain a set of latches of a bogie and/or a battery assembly.

### 3.1.1 Trailer Chassis

The trailer chassis can include a vehicle coupler to couple the trailer to a tow vehicle-such as a tractor unit, a hybrid tractor, an electric tractor, and/or an internal combustion engine tractor-in order to form a tractor-trailer (e.g., a semi-truck, a semi, an 18-wheeler). For example, the trailer chassis can include a kingpin arranged on a proximal end of the trailer chassis and configured to interface with a fifth wheel of a tractor.

### 3.1.2 Landing Gear

In one implementation, the trailer includes a landing gear configured to support the trailer. The trailer can further include a landing gear actuator arranged on the landing gear and configured to transition the landing gear from a retracted position (e.g., proximal the floor of the trailer chassis) to an extended position (e.g., engaging a ground surface below the trailer chassis) and thereby, enable a driver to park or dock the trailer in a service mode.

### 3.2 Bogie

The trailer can further include a bogie arranged below the trailer chassis. The bogie includes: a chassis; a set of latches; a driven axle suspended from the chassis; and a motor coupled to the driven axle.

In one implementation, the bogie includes: a chassis configured to transiently install on a left rail and a right rail of a trailer over a range of longitudinal positions; a set of latches configured to transiently engage a subset of engagement features, in the first array of engagement features on the left rail and in the second array of engagement features on the right rail, to retain the bogie below the trailer chassis; a driven axle suspended from the chassis; and a motor coupled to the driven axle configured to output torque to the driven axle in a tow mode and regeneratively brake the driven axle in a regenerative braking mode.

The chassis is configured to transiently install on a trailer over a range of longitudinal positions and supports the driven axle. The chassis can be manufactured from a metal such as stainless steel or galvanized steel and coupled to the floor of the trailer. Additionally, the chassis can be mounted to the floor such as by welding the chassis to the floor of the trailer or bolting the chassis to the floor of the trailer via a set of fasteners.

However, the chassis can be manufactured in any other way and transiently installed on the trailer in any other way.

### 3.2.1 Latches

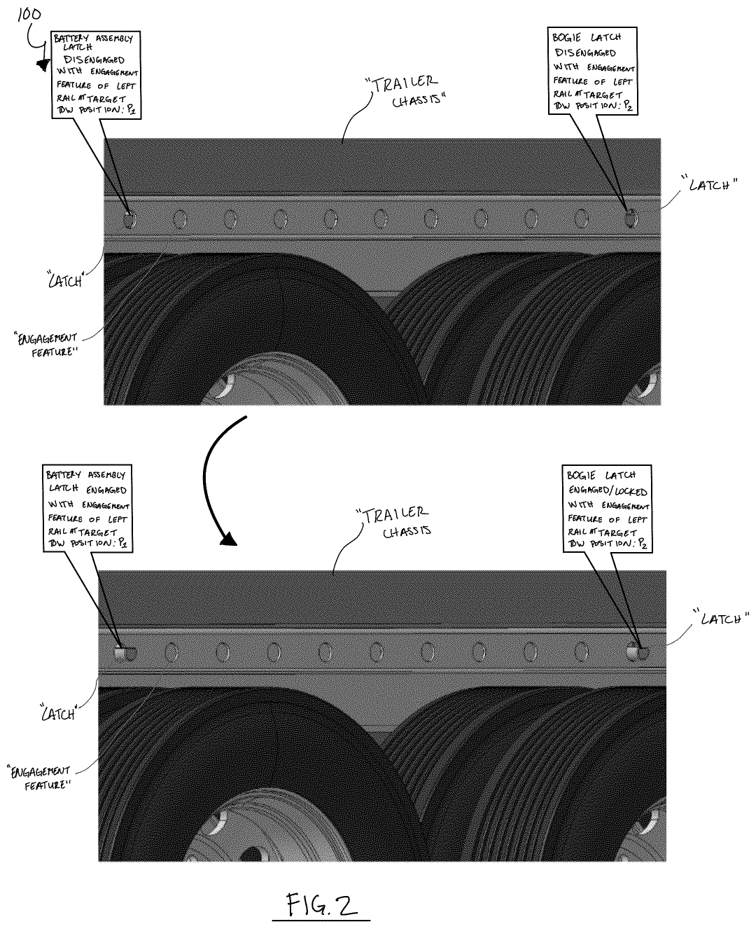

Generally, the set of latches are configured to cooperate with the array of engagement features distributed along the left rail and the right rail in order to retain the bogie below the floor of the trailer over a range of longitudinal positions, as shown in FIG. 2.

In one implementation, the set of latches are configured to transiently engage a first subset of engagement features, in a first array of engagement features on the left rail and in a second array of engagement features on the right rail of the trailer, to retain the bogie below the trailer chassis.

More specifically, in this implementation, each latch in the set of latches can include a solenoid (e.g., an electromechanical solenoid, a pneumatic solenoid), or another latch (e.g., an air pressure latch, a mechanical latch, an electromechanical latch) configured to transiently engage with a corresponding engagement feature in the array of engagement features distributed along the left rail and the right rail of the trailer. Further, each solenoid or other latch can be operable in an engaged position (e.g., a closed position) to engage and retain a corresponding engagement feature to couple the bogie to trailer chassis. In the engaged position, each solenoid or latch remains engaged with the corresponding engagement feature to prevent slippage of the bogie away from the trailer while the trailer is in motion. Alternatively, each solenoid or other electromechanical latch can be operable in a disengaged position (e.g., an open position) to disengage from the corresponding engagement feature and decouple the bogie from the trailer chassis and thereby, enable a user to move, service, and/or replace the bogie (e.g., clean the bogie, replace the motor, clean the driven wheels) without additional tools.

Additionally, each solenoid or other latch can be actuated by a physical key or via wireless communication with a computational device (e.g., a mobile phone, a tablet) of a user (e.g., an operator, a driver, a technician) in order to engage and disengage each solenoid or other electromechanical latch from the corresponding engagement feature on the left rail and the right rail, thereby enabling the user to freely guide the bogie along the left rail and the right rail to a target position to balance a load, contained in the trailer chassis, on the driven axle, to remove the bogie for service (e.g., replacement of the left driven wheel or the right driven wheel, replacement of the motor), or to remove the battery assembly for. Thus, the set of latches can cooperate with the engagement features of the left rail and the right rail to prevent unauthorized access and/or removal of the bogie from the trailer.

Alternatively, in the disengaged position, the set of solenoids can cooperate to actuate the bogie over a range of longitudinal positions between the left rail and the right rail responsive to a trigger from the controller. In particular, responsive to a trigger from the controller, the set of solenoids can advance the bogie to engage the battery assembly and drive the battery assembly, along the left rail and the right rail, to a target longitudinal position below the trailer chassis and to withdraw the bogie from the this target longitudinal position to a next target longitudinal position in order to balance a weight of the trailer, containing a load, on the driven axle.

However, the bogie can include any other type of latch or solenoid configured to support the longitudinal load of the bogie in an engaged position and to transiently install the bogie to the trailer over a range of longitudinal positions.

### 3.2.2 Clamp

In one variation, the system 100 can further include a clamp (e.g., a mechanical clamp, a hydraulic clamp, an electromechanical clamp, a locking pin) configured to engage the bogie, on a distal end of the trailer chassis, to the floor of the trailer. The clamp is further configured to prevent slippage of the set of rails along a longitudinal axis of the trailer and thus, the bogie once the set of latches are engaged with corresponding engagement features.

For example, a user or a forklift may: arrange the bogie below the floor of the trailer to align the set of latches with corresponding engagement features on the left rail and the right rail of the trailer. Then, the user or forklift may manipulate the bogie below the trailer chassis via the left rail and the right rail to guide the bogie toward a target position and balance a weight distribution of the trailer. Once the user confirms, via a wireless signal, that the bogie occupies the target position and engages the set of latches with the left rail and the right rail, the user may arrange the clamp in an engaged position to lock the bogie to the trailer and prevent slippage of the bogie away from the trailer in a tow mode or a service mode.

Alternatively, once the user confirms the bogie occupies the target position and the set of latches are in the engaged position with the left rail and the right rail, a controller can trigger an actuator to mechanically actuate the clamp into an engaged position to lock the bogie to the trailer and prevent slippage of the bogie away from the floor of the trailer.

Therefore, the clamp can cooperate with the set of latches to engage and retain the bogie below the floor of the trailer, prevent slippage of the bogie away from the floor of the trailer, and prevent unauthorized access and/or removal of the bogie from the trailer.

### 3.2.3 Driven Axle+Motor

The trailer further includes a driven axle supported by an axle housing, suspended from the trailer chassis, and includes a left driven wheel and a right driven wheel. The axle housing further encapsulates a motor mounted to the driven axle and is configured to protect the driven axle and the motor.

The motor is configured to drive the left driven wheel and the right driven wheel and thus, output torque in a torque output mode. The motor is further configured to regeneratively brake the left driven wheel and the right driven wheel to slow motion of the trailer in a regenerative braking mode.

In one variation, the trailer includes a passive axle, suspended from the trailer chassis, adjacent the driven axle and includes a left passive wheel and a right passive wheel. In this variation, the left passive wheel and the right passive wheel are configured to assist motion of the trailer when the left driven wheel and the right driven wheel are driven by the motor in the torque output mode.

### 3.2.4 Bogie Actuator

The trailer can include an electromechanical, pneumatic, or hydraulic bogie actuator; coupled to and arranged on the chassis of the bogie; and configured to advance the bogie to engage the battery assembly and drive the battery assembly to a target longitudinal position along the left rail and the right rail and to withdraw the bogie from the target longitudinal position to a next target longitudinal position in order to balance a weight of the trailer, containing a load, on the driven axle.

For example, responsive to a trigger from the controller, the bogie actuator can advance the bogie to engage the battery assembly, proximal the second end of the trailer chassis, and drive the battery assembly to a first target longitudinal position, proximal the first end of the trailer chassis opposite the second end. Then, responsive to a next trigger from the controller, the bogie actuator can withdraw or retract the bogie to a second target longitudinal position proximal the second end of the trailer chassis.

### 3.3 Battery Assembly

The trailer can further include a battery assembly configured to transiently install on the trailer over a range of longitudinal positions and electrically couple to the trailer by a power cable or integrated directly with the trailer chassis in order to supply power to the motor.

More specifically, the battery assembly can further supply electrical energy to the motor to output torque to the driven axle in a torque output mode and receive electrical energy from the motor to regeneratively brake the driven axle and charge the battery assembly in a regenerative braking mode. Further, the battery assembly can include a set of modular batteries configured to engage with each other and fit within a battery frame. The battery frame is configured to fit below a standard trailer chassis of a trailer between the left rail and the right rail and thus, enable a user to quickly and repeatably install the battery assembly or the set of modular batteries below a standard floor of any trailer. The set of modular batteries enables a user to selectively adjust the battery capacity of the battery assembly as a function of a predicted distance traveled by the trailer, a weight distribution of the trailer, and/or a type of the trailer (e.g., a dry van trailer, a refrigerated trailer).

In one implementation, the battery assembly includes a set of latches configured to: transiently engage a subset of engagement features, in the first array of engagement features on the left rail and in the second array of engagement features on the right rail; and to retain the battery assembly below the trailer chassis. In this implementation, each latch in the set of latches can include a solenoid (e.g., an electromechanical solenoid, a pneumatic solenoid), or another latch (e.g., an air pressure latch, a mechanical latch, an electromechanical latch) operable in an engaged position and a disengaged position to transiently engage and/or disengage a corresponding engagement feature distributed along the left rail and the right rail of the trailer.

In one example, the battery assembly can include a set of cylindrical modular batteries to connect at a top and a bottom of the battery to engage each other modular battery in the set of cylindrical modular batteries. In this example, a first modular battery in the set of modular batteries can include an adapter configured to electrically couple the battery assembly to the motor.

However, each modular battery in the battery assembly can define any other shape and electrically couple to the motor in any other way. Alternatively, the battery assembly can directly connect to the motor with a power cable.

### 3.4 Sensors

The system 100 can further include a set of sensors including force sensors (e.g., a strain gauge, an inertial measurement unit, a load cell), position sensors (e.g., a linear encoder, a rotary encoder, a distance sensor), optical sensors (e.g., a one-dimensional depth sensor, a LIDAR sensor, an RGB camera), inertial sensors (e.g., an inertial measurement unit, an accelerometer, a gyroscope); and/or proximity sensors (e.g., an electromagnetic field sensor, a Hall effect sensor, a conductive sensor, an inductive sensor).

In one variation, the set of rails are configured to support and guide the bogie along a range of longitudinal positions below the trailer chassis and each rail includes a position sensor, such as a linear encoder, coupled to or integrated into the rail. In this variation, the controller can track or read the longitudinal position of each rail—and therefore the bogie—within the system 100 from this linear encoder.

In another variation, the bogie includes a position sensor such as a linear encoder coupled to or integrated into the driven axle. The controller can track or read longitudinal positions of the driven axle and thus, the bogie, within the system 100 from this linear encoder.

In yet another variation, the bogie can include a load cell configured to output signals representing weights of the trailer on the driven axle. The load cell can transmit these signals to the controller to monitor a weight distribution of the trailer and selectively transition between a tow mode and a service mode.

### 4. Controller

The controller is coupled to actuators and sensors within the system 100 and executes methods and techniques described below to autonomously transition between a service mode and a tow mode responsive to local conditions detected by the system 100 and selectively adjust the bogie and the battery assembly over a range of longitudinal positions below the trailer chassis and thereby, balance a weight distribution of the trailer on the driven axle.

### 5. Setup Period

Generally, during a setup period, the controller can retrieve a drive route for the trailer defining a start location and a target location, a set of weight parameters, and/or a target battery capacity associated with the drive route entered by a user from a user portal. The controller can then estimate a target tow position of the bogie and a target position of the battery assembly for each leg of the drive route based on the set of weight parameters and annotate each leg of the drive route with these target tow positions to generate a specification for the trailer.

In one implementation, the controller can retrieve a drive route and a set of weight parameters (e.g., a set of weight requirements, a set of weight limitations, a set of weight regulations) entered by a user via a user portal. The controller can then define a target tow position of the bogie and the battery assembly for the drive route based on this set of weight parameters. The controller can access these target tow positions and the drive route at the commencement of a service mode and selectively adjust the bogie and the battery to these target tow positions below the trailer chassis.

In another implementation, the controller can retrieve a drive route defining a start location, a target location, a set of legs annotated with locations between the start location and target location and access a set of weight parameters from a weight parameter database associated with this particular drive route. The controller can then: define a target tow position of the bogie and the battery assembly for each leg in the set of legs of the drive route; and annotate each leg in the drive route with the target tow position of the bogie and the battery assembly to generate a specification for the trailer. The controller can access this specification at the commencement of a service mode and selectively adjust the bogie and the battery to these target tow positions below the trailer chassis, as further described below.

### 5.1 Drive Route+Specification

In one variation, the controller can retrieve a drive route defining a start location, a target location, a set of legs annotated with locations between the start location and the target location, and a set of weight parameters—such as a kingpin-to-rear-axle length requirement, a gross weight limit for the tractor-trailer, and a maximum weight limit for the driven axle and the passive axle of 34,000 pounds via the user portal entered by a user via a user portal. The controller can then define a target tow position of the bogie and the battery assembly for the drive route according to this set of weight parameters.

For example, a user may enter a short-range drive route of 120 miles for a tractor-trailer defining a 37.335480 latitude and −121.893028 longitude of a tractor-trailer yard as the start location, defining a 38.575764 latitude and −121.478851 longitude of a warehouse as the target location, and a set of legs annotated with a set of locations between the start location and target location via the user portal. The user may then enter a set of weight limitations, associated with the drive route, including a kingpin-to-rear-axle length requirement of 40 feet, a gross weight limit for the tractor-trailer of 80,000 pounds, and a maximum weight limit for the driven axle and the passive axle of 34,000 pounds via the user portal. Based on this set of weight limitations, the controller can define a target tow position of the bogie and the battery assembly for the drive route in order to balance a weight distribution of the trailer on the driven axle.

In another variation, the controller can retrieve a drive route defining a start location and a target location and access a set of weight limitations from a weight limitation database for each leg of the drive route. The controller can then define a target tow position of the bogie and the battery assembly for the drive route based on this set of weight parameters.

For example, the controller can retrieve a long-range drive route of 181miles defining a start location in Connecticut with a 41.599998 latitude and −72.699997longitude and a target location in New York with a 40.730610 latitude and −73.935242longitude. The controller can then access a first set of weight limits—such as a first kingpin-to-rear-axle length limit of 43 feet, a first gross weight limit for the tractor-trailer of 80,000 pounds, a first maximum weight limit for the driven axle and the passive axle of 36,000 pounds—from a weight limitation database for Connecticut. The controller can then: scan the set of legs of the drive route; identify a first leg of the drive route annotated with a 41.763710 latitude and −72.685097 longitude located within Connecticut; define a first target tow position of the bogie based on the kingpin-to-rear-axle length requirement of 43 feet for Connecticut; define a second target tow position of the battery assembly based on the gross weight limit for the tractor-trailer of 80,000 pounds and the maximum weight limit for the driven axle and the passive axle of 36,000 pounds for Connecticut; and annotate the first leg of the drive route with the first target tow position of the bogie and the second target tow position of the battery assembly.

The controller can then access a second set of weight limits—such as a second kingpin-to-rear-axle length requirement of 41 feet, a second gross weight limit for the tractor-trailer of 80,000 pounds, a second maximum weight limit for the driven axle of 34,000 pounds—from a weight limitation database for New York. The controller can: scan the set of legs of the drive route; identify a last leg of the drive route annotated with a 40.749859 latitude and −73.847595 longitude corresponding to New York; define a third target tow position of the bogie based on the kingpin-to-rear-axle length requirement of 41 feet for New York; define a fourth target tow position of the battery assembly based on the gross weight limit for the tractor-trailer of 80,000 pounds and the maximum weight limit for the driven axle of 20,000 pounds for New York; and annotate the first leg of the drive route with the third target tow position of the bogie and the fourth target tow position of the battery assembly.

The controller can then repeat these methods and techniques for each other leg of the drive route annotated with a latitude and a longitude corresponding to Connecticut and for each other leg of the drive route annotated with a latitude and a longitude corresponding to New York to generate a specification for the trailer corresponding to this particular drive route between Connecticut and New York.

### 5.2 Installation

Generally, a user (e.g., an operator, a driver, a yard manager) operates the tow vehicle coupled to the trailer in a reverse direction of motion to locate the trailer at a target position such that the trailer occupies a docking station within a tow vehicle yard in preparation for installation. Then, the controller can: detect absence of motion and air pressure via a pressure sensor coupled to the gladhand of the tow vehicle; detect a location of the trailer; and, in response to the location corresponding to a known location of the tow vehicle yard, access a specification for this tractor-trailer.

In one variation, the bogie includes a compressed-air-brake system configured to couple to a gladhand of a brake line from a tow vehicle coupled to the trailer and brake the driven axle responsive to compressed air signals received from the tow vehicle via the gladhand. For example, an operator may manually couple a supply line such as an emergency brake line and a control line such as a service brake line of the trailer to a compressed air supply line of the tractor via a set of gladhand couplers. The user may then couple a compressed-air-brake system of the bogie to the gladhand coupling between the tractor and the trailer. Responsive to compressed air signals received from the tractor via the gladhand, the controller can detect absence of motion of the trailer and trigger the bogie actuator to advance the bogie to a target tow position below the trailer chassis.

### 5.3 Initial Target Tow Positions

Next, the controller can extract a first target tow position of the bogie and the second target tow position of the battery assembly from the specification and selectively trigger the bogie actuator to drive the bogie and the battery assembly to the corresponding target tow position below the trailer chassis. The controller can detect a position of the bogie via a proximity sensor to verify each target tow position.

In one variation, the controller can extract a first target tow position of the bogie and the second target tow position of the battery assembly from the specification, trigger the bogie actuator to advance the bogie to engage the battery assembly and drive the battery assembly to the second target tow position; and trigger the bogie actuator to withdraw the bogie to the first target tow position to balance a weight of the trailer, containing a first load, on the driven axle. The system 100 can further include a first proximity sensor coupled to the trailer chassis adjacent the left rail and a second proximity sensor adjacent the right rail of the trailer and each proximity sensor configured to output signals representing a position of the bogie relative to the trailer chassis. The controller can then access a signal, detect a position of the bogie based on the signal, and verify that the position of the bogie is analogous to (e.g., matches, corresponds to) the target tow position.

For example, the controller can: extract a first target tow position of the bogie proximal a second end of the trailer from the specification; extract a second target tow position of the battery assembly proximal a first end of the trailer from the specification; trigger the bogie actuator to advance the bogie to engage the battery assembly and drive the battery assembly to the second target tow position; and trigger the bogie actuator to withdraw the bogie to the first target tow position. The controller can then: access a first signal from the left proximity sensor; access a second signal from the right proximity sensor; derive a position of the bogie relative to the trailer chassis based on the first signal and the second signal; and, in response to the position corresponding to the first target tow position, confirm the second target tow position of the bogie and the first target tow position of the battery assembly.

Alternatively, the controller can operate the set of latches of the bogie to the disengaged position and trigger the set of latches to actuate the bogie over a range of longitudinal positions between the left rail and the right rail rather than trigger the bogie actuator to drive and/or withdraw the bogie and the battery assembly. For example, the controller can initiate a wireless communication protocol to disengage the set of latches of the bogie from the left rail and the right rail and then trigger the set of latches to advance the bogie to engage the battery assembly and drive the battery assembly, along the left rail and the right rail, to the second target tow position below the trailer chassis. The controller can then trigger the set of latches to withdraw the bogie from the second target tow position to the first target tow position in order to balance a weight of the trailer, containing a load, on the driven axle.

Thus, the controller can trigger the bogie actuator or the set of latches to adjust the longitudinal position of the bogie and the battery assembly below the trailer chassis and confirm a target tow position of the bogie and the battery assembly via proximity sensors coupled to the trailer chassis.

### 5.2 Weight Distribution

Once the bogie occupies the second target tow position and the battery assembly occupies the first target tow position, the controller can confirm the weight of the trailer on the driven axle via a load cell. The system 100 can further include a load cell coupled to the driven axle and configured to output signals corresponding to weights of loads, contained in the trailer chassis, on the driven axle. The load cell can transmit these signals to the controller to confirm the weight distribution of the trailer on the driven axle and to autonomously transition to a tow mode.

In one implementation, the controller can: access a signal from the load cell coupled to the driven axle; interpret a weight of a load, contained in the trailer chassis, on the driven axle based on the signal received from the load cell and, in response to the weight falling within a target weight range and/or below a threshold weight defined in the specification, enter a tow mode.

For example, the controller can: access a signal from the load cell coupled to the driven axle; detect a weight of 34,200 pounds associated with a cargo load, contained in the trailer chassis, on the driven axle based on the signal; access the specification for the trailer; extract a maximum weight limit of 34,000 pounds on the driven axle and, in response to the first weight of 34,200 pounds exceeding the maximum weight limit of 34,000 pounds on the driven axle, define a new target tow position for the bogie and the battery assembly to reduce the weight on the driven axle. The controller can then implement methods and techniques described above to trigger the bogie actuator to advance the bogie to engage the battery assembly and drive the battery assembly to the new target tow position; and trigger the bogie actuator to withdraw the bogie to the next target tow position to balance the weight on the driven axle.

Then, the controller can: access a next signal from the load cell coupled to the driven axle; interpret a weight of 33,550 pounds associated with the cargo load, contained in the trailer chassis, on the driven axle based on this signal; and, in response to the first weight of 33,500 pounds falling within a target weight range between 33,000pounds and 34,000 pounds, enter a tow mode and trigger the battery assembly to supply electrical energy to the motor to output torque to the driven axle.

Therefore, the controller can access signals received from a load cell and interpret a weight of the trailer on the driven axle. Then, responsive to the weight exceeding a maximum weight limit on the driven axle, the controller can selectively adjust the target tow position of the bogie and the battery assembly to balance a weight distribution of the trailer. Alternatively, responsive to the weight falling below the maximum weight limit on the driven axle or within a target weight range, the controller can autonomously transition to a tow mode.

### 6. Tow Mode

Generally, once the controller verifies the target tow position of the bogie, the target tow position of the battery assembly, and the weight distribution of the trailer, the user (e.g., an operator, a driver, a yard manager) or a machine (e.g., a forklift) may couple the hitch of the tow vehicle to the kingpin and the controller can identify a coupling event between the kingpin (e.g., via a signal from a force sensor) and the hitch of the tow vehicle. In particular, the controller can: detect an initial force impulse applied to the kingpin; interpret the initial force impulse as a coupling event with the hitch of the tow vehicle; and, in response to interpreting the initial force impulse as the coupling event with the hitch of the tow vehicle, enter a tow mode.

In one implementation, in tow mode, the controller can detect conditions of the trailer such as: a presence or absence of motion of the trailer; a tractor-trailer (e.g., a steering angle); a speed of the trailer; a location of the trailer; forces applied to the kingpin; a charge state of the battery assembly; and/or a weight of the trailer on the driven axle. The controller can then: calculate a target preload force proportional to and/or inversely proportional to the condition of the trailer; and trigger the motor to increase torque output and/or reduce torque output in a direction of motion of the trailer to decrease a difference between the target preload force and a total force applied to the kingpin to control the trailer in conjunction with the tow vehicle. Further, the controller can: detect absence of motion of the trailer (i.e., the trailer is stationary or immobile); detect a charge state of the battery assembly; and, in response to the charge state of the battery assembly exceeding a threshold charge state, selectively trigger the bogie actuator to adjust the bogie below the trailer chassis to a target wheelbase position to balance a weight of the trailer on the driven axle.

### 6.1 Variation: Target Wheelbase

In one variation, a user may wish to define a target wheelbase—such as a distance between a center of a set of wheels coupled to the first end of the trailer chassis to the center of the set of driven wheels—for a drive route of a tractor-trailer to reduce the fuel consumption of the tow vehicle or to enable the tractor-trailer to exhibit a tractor-trailer angle within a target turning radius during the drive route. In this variation, the controller can: define a new target tow position for the bogie; detect absence of motion of the trailer (i.e., the trailer is stationary or immobile) for a duration of time; and, in response to the duration exceeding a threshold duration, trigger the bogie actuator to advance and/or withdraw the bogie to the new target tow position of the bogie to achieve the target wheelbase in the tow mode.

For example, in the tow mode during the drive route, the controller can: detect absence of motion of the trailer of o miles-per-hour for a duration of five minutes; and, in response to the duration of five minutes exceeding a threshold duration of three minutes, generate a prompt for the driver to park the tractor-trailer and transmit the prompt to a display within the tow vehicle for the driver. Then, responsive to the driver's confirmation of the tractor-trailer as parked, the controller can: automatically unlock the set of latches of the bogie from a corresponding engagement feature of the left rail and the right rail to an open position; trigger the bogie actuator to adjust the bogie along the left rail and the right rail to the new target tow position; detect a position of the bogie via proximity sensors coupled to the trailer chassis; and, in response to the position corresponding to the new target tow position of the bogie, automatically lock the set of latches of the bogie with a corresponding engagement feature of the left rail and the right rail in an engaged position, generate a prompt for the driver to resume the drive route, and transmit the prompt to the display within the tow vehicle.

Therefore, in tow mode, the controller can selectively adjust the target tow position of the bogie and/or the battery assembly below the trailer chassis to achieve a target wheelbase defined by the user when the trailer is immobile for a duration of time.

### 7. Service Mode

Generally, a user (e.g., an operator, a driver, a yard manager) operates the tow vehicle coupled to the trailer in a reverse direction of motion to locate the trailer at a target position such that the trailer occupies a docking station within a warehouse in preparation for service. Then, the controller can: detect absence of motion and air pressure via a pressure sensor coupled to the gladhand of the tow vehicle; detect a location of the trailer; and, in response to the location corresponding to a known location of the warehouse, enter a service mode.

In one implementation, once in the service mode, the controller can autonomously unlock the set of latches of the bogie and the battery assembly, trigger the bogie actuator to locate the bogie in a service position below the trailer chassis, and monitor a charge state of the battery assembly. The controller can then implement methods and techniques described above to autonomously service the bogie and/or the battery assembly in the service mode. Further, the controller can monitor the charge state of the battery assembly and, responsive to the charge state of the battery assembly falling below a threshold charge state: identify the battery assembly as depleted; automatically unlock the set of latches of the bogie from a corresponding engagement feature of the left rail and the right rail to an open position; and automatically trigger the bogie actuator to drive the bogie along the left rail and right rail to a service position below the trailer chassis. The bogie can further include a set of booms coupled to the chassis of the bogie and configured to extend to engage a battery assembly and to retract to remove or replace the battery assembly. The controller can then manipulate the set of booms to engage and remove the depleted battery assembly, place the depleted battery assembly in a depleted battery bin within the tow vehicle depot, and replace the depleted battery assembly with a new battery assembly. Thus, the controller can unlock the set of latches of the bogie, locate the bogie in a service position, monitor the charge state of the battery assembly, and manipulate a set of booms coupled to the bogie to autonomously service the battery assembly in the service mode.

In another implementation, once in the service mode, the controller can monitor the charge state of the battery assembly and, responsive to the charge state of the battery assembly falling below a threshold charge state: identify the battery assembly as depleted; automatically unlock the set of latches of the bogie from a corresponding engagement feature of the left rail and the right rail to an open position; and automatically trigger the bogie actuator to drive the bogie along the left rail and right rail to a service position below the trailer chassis. The user may then manually service the battery assembly in the service mode. Thus, the controller can autonomously prepare the battery assembly for service and reduce the duration for the user to manually service the battery assembly.

In one variation, the bogie can further include a secondary battery assembly mounted to the chassis of the bogie, and the controller can trigger the secondary battery assembly to supply electrical energy to the motor to assist motion of the bogie away from the trailer and thus enable a user to service the bogie—such as to replace the motor, replace the driven axle, clean the bogie, or replace the bogie—in the service mode.

### 7.1 Manual Battery Assembly Replacement

In one implementation, the controller can prepare the battery assembly for manual service from an operator by detecting absence of motion of the trailer, monitoring the charge state of the battery assembly, and automatically locating the bogie in a service position below the trailer chassis. The controller can further trigger the set of latches of the battery assembly to an open position and trigger the landing gear actuator to drive the landing gear to engage a ground surface in order to prepare the battery assembly for manual service by a user.

In one variation, when the trailer is docked at a loading dock within a warehouse or a depot, the controller can detect a charge state of a battery assembly of the trailer and, in response to the charge state of the battery assembly falling below a threshold charge state, generate a notification indicating the charge state and a prompt for a user to remove the battery assembly. Further, the controller can: access the specification of the trailer; extract a service position of the bogie from the specification; and trigger the bogie actuator to drive the bogie between the left rail and the right rail to the service position. The controller can then detect a position of the bogie via a proximity sensor and, in response to the position corresponding to the service position, enter a service mode.

For example, the controller can detect the location of a trailer at a rest stop parking lot and detect the battery assembly as depleted. The user may then wish to replace the battery assembly at the rest stop parking lot. The controller can: detect a charge state of the battery assembly; and, in response to the charge state falling below a threshold charge state, identify the battery assembly as depleted and generate a notification for the user to replace the battery assembly. Responsive to positive feedback from the user confirming replacement of the battery assembly, the controller can trigger the landing gear actuator to drive the landing gear to engage a ground surface below the trailer and trigger the bogie actuator to drive the bogie along the left rail and the right rail to the service position.

Once in the service position, the operator may locate a jack proximal the trailer chassis and extend the jack to raise the trailer bed to expose the bogie. Then, the controller can: trigger the latch actuator to release the subset of latches of the battery assembly from the corresponding subset of engagement features of each rail to prepare the battery assembly for replacement. The operator may then: manipulate a machine (e.g., a forklift) to align with the floor of the trailer chassis; drive the forklift below the trailer chassis to engage the depleted battery assembly; retract the forklift from the trailer chassis to remove the depleted battery assembly and transport the depleted battery assembly to a used storage battery bin; and collect a new battery assembly via the forklift and align with the floor of the trailer chassis to locate the new battery assembly between the left rail and the right rail below the trailer chassis. Accordingly, the controller can: trigger the bogie actuator to drive the bogie to engage the battery assembly and drive the battery assembly to a target tow position; trigger the latch actuator to lock the subset of latches of the battery assembly with the corresponding subset of engagement features of the battery assembly to the left rail and the right rail to retain the new battery assembly; and trigger the landing gear actuator to retract the landing gear to disengage from the ground surface in the rest stop parking lot.

Alternatively, the operator may manually maneuver the bogie along the left rail and the right rail to the service position and release each latch in the subset of latches of the battery assembly. The operator may then: manipulate the forklift to align with the floor of the trailer chassis; drive the forklift below the trailer chassis to engage the depleted battery assembly; retract the forklift from the trailer chassis to remove the depleted battery assembly and transport the depleted battery assembly to a used storage battery bin; collect a new battery assembly via the forklift and align with the floor of the trailer chassis to locate the new battery assembly between the left rail and the right rail below the trailer chassis at a target tow position; and manually lock each latch in the set of latches of the battery assembly to the corresponding engagement feature of the left rail and the right rail to retain the new battery assembly below the trailer chassis.

Therefore, the controller can automatically locate the bogie and battery assembly in a service position and enable a user to manually service the depleted battery assembly quickly and repeatably. Further, the controller can monitor the charge state of the battery assembly and notify a user that the battery assembly is depleted, and the user may manually replace the battery assembly with a new battery assembly.

### 7.2 Autonomous Battery Assembly Replacement

In one variation, the controller can monitor the charge state of the battery assembly and, responsive to the charge state of the battery assembly falling below a threshold charge state, identify the battery assembly as depleted and generate a notification for a user to replace the depleted battery assembly. The controller can then autonomously unlock the set of latches of the bogie from a corresponding engagement feature of the left rail and the right rail to an open position; trigger the bogie actuator to drive the bogie along the left rail and right rail to a service position below the trailer chassis; and manipulate the set of booms to service the depleted battery assembly.

For example, the controller can detect the charge state of the battery assembly and, based on the charge state, identify the battery assembly as depleted and implement methods and techniques described above to autonomously replace the battery assembly inside a docking station while the trailer is docked. Further, the operator may locate a set of jacks proximal the trailer chassis and extend the set of jacks to raise the floor of the trailer chassis and expose the bogie.

The controller can then: trigger the landing gear actuator to drive the landing gear to engage with a ground surface of the docking station; execute a wireless communication protocol to release the set of latches of the depleted battery assembly from the corresponding engagement feature of the left rail and the right rail; trigger an actuator to advance the set of booms to a service position to engage the depleted battery assembly; trigger the actuator to extend the set of booms to locate the depleted battery assembly above a used battery storage bin and release the depleted battery assembly into the storage bin; trigger the actuator to advance the set of booms to engage a new battery assembly; and trigger the actuator to retract the set of booms and locate a new battery pack below the trailer chassis between the left rail and the right rail. The controller can execute the wireless communication protocol to engage the set of latches of the new battery assembly in a closed position to retain the new battery assembly below the trailer chassis; access the specification for the trailer; extract a target to position for the bogie; and trigger the bogie actuator to reset the bogie to the target tow position for a subsequent drive route.

Therefore, the controller can implement Blocks of the method S100 to detect the battery assembly as depleted and manipulate actuators to maneuver the bogie to a service position and autonomously replace the depleted battery assembly with a new battery assembly.

The systems and methods described herein can be embodied and/or implemented at least in part as a machine configured to receive a computer-readable medium storing computer-readable instructions. The instructions can be executed by computer-executable components integrated with the application, applet, host, server, network, website, communication service, communication interface, hardware/firmware/software elements of a user computer or mobile device, wristband, smartphone, or any suitable combination thereof. Other systems and methods of the embodiment can be embodied and/or implemented at least in part as a machine configured to receive a computer-readable medium storing computer-readable instructions. The instructions can be executed by computer-executable components integrated by computer-executable components integrated with apparatuses and networks of the type described above. The computer-readable medium can be stored on any suitable computer readable media such as RAMs, ROMs, flash memory, EEPROMs, optical devices (CD or DVD), hard drives, floppy drives, or any suitable device. The computer-executable component can be a processor but any suitable dedicated hardware device can (alternatively or additionally) execute the instructions.

As a person skilled in the art will recognize from the previous detailed description and from the figures and claims, modifications and changes can be made to the embodiments of the invention without departing from the scope of this invention as defined in the following claims.

I claim:

1. A system for weight distribution of a trailer comprising:
a trailer chassis comprising a vehicle coupler arranged on a first end of the trailer chassis and configured to couple to a tow vehicle;
a battery assembly arranged on the first end of the trailer chassis and configured to transiently install on a left rail and a right rail of the trailer over a range of longitudinal positions;
a bogie comprising:
a chassis configured to transiently install on the left rail and the right rail of the trailer over the range of longitudinal positions and arranged on the second end of the trailer chassis opposite the first end;
a driven axle suspended from the chassis; and
a motor coupled to the driven axle;
a bogie actuator configured to longitudinally displace the bogie along the trailer chassis;
a controller configured to:
at an initial time:
access a specification for the trailer defining a total weight for the trailer and defining a target length between the vehicle coupler and the driven axle;
define a first target tow position of the bogie based on the target length between the vehicle coupler and the driven axle;
define a second target tow position of the battery assembly based on the total weight for the trailer and the first target tow position;
trigger the bogie actuator to advance the bogie to engage the battery assembly and drive the battery assembly to the second target tow position; and
trigger the bogie actuator to withdraw the bogie to the first target tow position to balance a weight of the trailer, containing a first load, on the driven axle;
at a first time:
detect a first weight of the trailer, containing the first load, on the driven axle; and
in response to the first weight of the trailer falling within a target weight range of the trailer on the driven axle, enter a tow mode and trigger the battery assembly to supply electrical energy to the motor to output torque to the driven axle.
